(19) United States
(12) Patent Application Publication
(10) Pub. No.: US 2018/0359023 A1
(43) Pub. Date: Dec. 13, 2018

(54) SYSTEM INTEGRATION OF SOLAR PANELS/CELLS AND ANTENNAS (SPAN SYSTEM)

(71) Applicant: Keysight Technologies, Inc., Santa Rosa, CA (US)

(72) Inventor: Michael W. Howard, Kimballton, IA (US)

(21) Appl. No.: 15/618,591

(22) Filed: Jun. 9, 2017

(51) Int. Cl. H04B 7/185

(52) U.S. Cl. CPC H04B 7/18515; H04B 7/18513

(57) ABSTRACT

Example embodiments relate to systems that use solar powered antennas. In some systems, the antennas are integrated with solar panels to facilitate communication in remote areas. In some systems the solar powered antennas may communicate with satellites to provide an Internet connection. In some systems the solar powered antennas may be used for interplanetary communication.

### BACKGROUND

### 1. Field

Example embodiments relate to systems that use solar powered antennas. In some systems, antennas are integrated with solar panels to facilitate communication in remote areas. In some systems, solar powered antennas may communicate with satellites to provide an Internet connection. In some systems the solar powered antennas may be used for global and/or interplanetary communication.

### 2. Description of the Related Art

The Internet is used by millions of people to obtain and exchange information. Unfortunately, many people do not have access to the Internet. In fact, as of 2016, more than four billion people, mostly in developing countries, lack access to the Internet. Some entrepreneurs have proposed increasing access to the Internet by providing a large network of small satellites spanning the globe. This approach, however, fails to solve many of the actual barriers to Internet access. For example, many of the people without Internet access do not have proper electricity on the ground. Without proper electricity, the ability to run communication equipment is extremely limited.

### SUMMARY

Example embodiments relate to systems that use solar powered antennas. In some systems, antennas are integrated with solar panels to facilitate communication in remote areas. In some systems, solar powered antennas may communicate with satellites to provide an Internet connection. In some systems solar powered antennas may be used for global and/or interplanetary communication.

In accordance with example embodiments, a global wide web (GWW) may include a plurality of ground based communication systems having at least one solar panel with at least one integrated antenna configured to operate in at least one of the very high frequency, ultrahigh frequency, and mm frequency range. The global wide web (GWW) may further include a first plurality of satellites orbiting the Earth, wherein the first plurality of satellites is configured to communicate directly with one another and with at least one of the ground based communication systems, wherein at least one of the plurality of satellites has a connection to the Internet to thereby allow all of the ground based communication systems to have an Internet connection.

### BRIEF DESCRIPTION OF THE DRAWINGS

Example embodiments are described in detail below with reference to the attached drawing figures, wherein:

FIG. 1 is a view of a system in accordance with example embodiments;

FIG. 2A a partial view of an antenna integrated with a solar panel in accordance with example embodiments;

FIG. 2B a front view of an antenna integrated with a solar panel in accordance with example embodiments;

FIG. 2C close up view of an antenna integrated with a solar panel in accordance with example embodiments;

FIG. 2D is another close up view of an antenna integrated with a solar panel in accordance with example embodiments;

FIG. 2E a back view of an antenna integrated with a solar panel in accordance with example embodiments

FIG. 3A is a view of a system in accordance with example embodiments;

FIG. 3B is a view of an RF/DC Isolator in accordance with example embodiments;

FIG. 4 is a view of a system in accordance with example embodiments;

FIG. 5 is a view of a system in accordance with example embodiments;

FIG. 6 is a view of a system in accordance with example embodiments;

FIG. 7 is a view of a system in accordance with example embodiments;

FIG. 8 is a schematic view of a conventional telecommunication system along with inventor's communication system in accordance with example embodiments;

FIG. 9 is a schematic view of a nonlimiting example of a communication system in accordance with example embodiments; and

FIG. 10 is a schematic view of a nonlimiting example of a communication system in accordance with example embodiments.

### DETAILED DESCRIPTION

Example embodiments will now be described more fully with reference to the accompanying drawings. Example embodiments are not intended to limit the invention since the invention may be embodied in different forms. Rather, example embodiments are provided so that this disclosure will be thorough and complete, and will fully convey the scope of the invention to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the invention since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to systems that use solar powered antennas. In some systems, the antennas are integrated with solar panels to facilitate communication in remote areas. In some systems the solar powered antennas may communicate with satellites to provide an Internet connection. In some systems the solar powered antennas may be used for global and/or interplanetary communication.

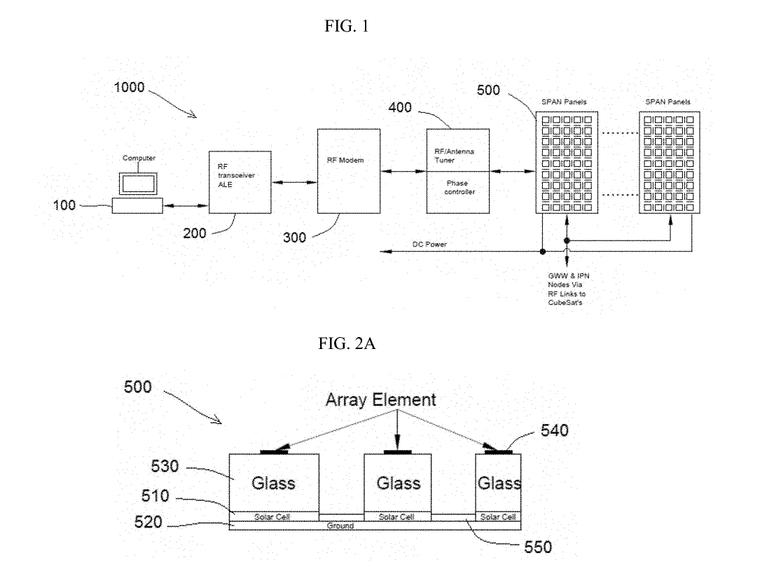

FIG. 1 is a view of a communication system 1000 in accordance with an example embodiment. As shown in FIG.1, the communication system 1000 is comprised of a computer 100, a radio frequency (RF) transceiver 200, an RF modem 300, an RF antenna and tuner and phase controller 400, and at least one solar powered antenna 500. In this nonlimiting example embodiment, the communication system 1000 may be fixed or it may be mobile. For example, the communication system 1000 may be truck mounted, mounted on a ship, or mounted on an airplane thus making the communication system 1000 mobile. In the alternative, the communication system 1000 may be fixed to the ground. In another embodiment, certain elements of the system 1000 may be mobile, for example, the computer 100, while other elements may be fixed, for example, the solar powered antenna 500. These specific examples are exemplary in nature only and are not intended to limit the invention since the invention may cover systems in which various parts are mobile while other parts are fixed.

In example embodiments, the computer 100 may be a general purpose computer having a processor, a display, and an input device such as a keyboard, a mouse, or a touch screen. The computer 100 may enable a user to receive data from the solar powered antenna 500 and/or send data to the solar powered antenna 500. In some embodiments, the computer 100 may be further configured, with the proper computer programs (for example, ALE (Automatic Link Enabling)), to control various elements of the communication system 1000. For example, the computer 100 may be configured to control various aspects of the solar powered antenna 500.

In example embodiments, the computer 100 may be set up for wireless and/or wired communication. For example, the computer 100 may include various antennas (for example, patch antennas, slot antennas, and/or dipole antennas) allowing the computer 100 to communicate wirelessly with another device, for example, the RF transceiver 200. On the other hand, the communication between the computer 100 and the other devices may be over a wire, for example, an Ethernet cable or some other conventional wiring. The computer 100, however, may be embodied in different forms such as, but not limited to, a cell phone, an i-pad, or any other device which includes electronic processors to enable digital and/or analog communication.

In example embodiments, the RF transceiver 200 may be configured to exchange information between the computer 100 and the RF modem 300 and may be configured to initiate and sustain radio communications. For example, in the event an artisan wished to configure the RF transceiver 200 as a high frequency (HF) transceiver the artisan may configure the RF transceiver 200 as an ALE (automatic link establishment) RF transceiver. As one skilled in the art would know, ALE is the worldwide standard for digitally initiating and sustaining HF radio communications. ALE enables a transceiver to make contact, or initiate a circuit, between itself and another transceiver or network of transceivers. In example embodiments, ALE may provide a reliable rapid method of calling and connecting during constantly changing HF ionospheric propagation, reception and interference and shared spectrum use of busy or contested HF channels. It is understood that while the RF transceiver 200 may be configured as an ALE transceiver, this is not intended to limit the invention since the invention anticipates using other standards, now, or developed in the future, which may facilitate radio communication.

The RF modem 300 may be configured to transfer data between the RF transceiver 200 and the RF/Antenna Tuner and Phase controller 400. In one nonlimiting example embodiment, the transfer of data may be done wirelessly over a relatively long distance, for example, up to tens of kilometers. In this nonlimiting example embodiment, the RF modem 300 may enable the creation of a Private Radio Networks (PRN) to allow real time communication. An advantage of the RF Modem 300 is that allows users to function independently of telecommunication or satellite network operators. In example embodiments, Ultra High Frequency (UHF) or Very High Frequency (VHF) communication bands may be exploited using the RF Modem 300. In example embodiments, licensed frequencies for a system 1000 may be reserved to reduce a likelihood of radio interference from other RF transmitters.

In example embodiments, the RF/Antenna tuner and phase controller 400 may be configured to exchange data between the RF Modem 300 and the solar powered antenna 500. For example, the RF/Antenna tuner and phase controller 400 may receive a radio frequency (RF) transmission like radio broadcasts from the solar powered antenna 500 and convert the selected carrier frequency and its associated bandwidth into a fixed frequency that is suitable for further processing. For example, the RF/Antenna tuner and phase controller 400 may convert the selected carrier frequency to a lower frequency.

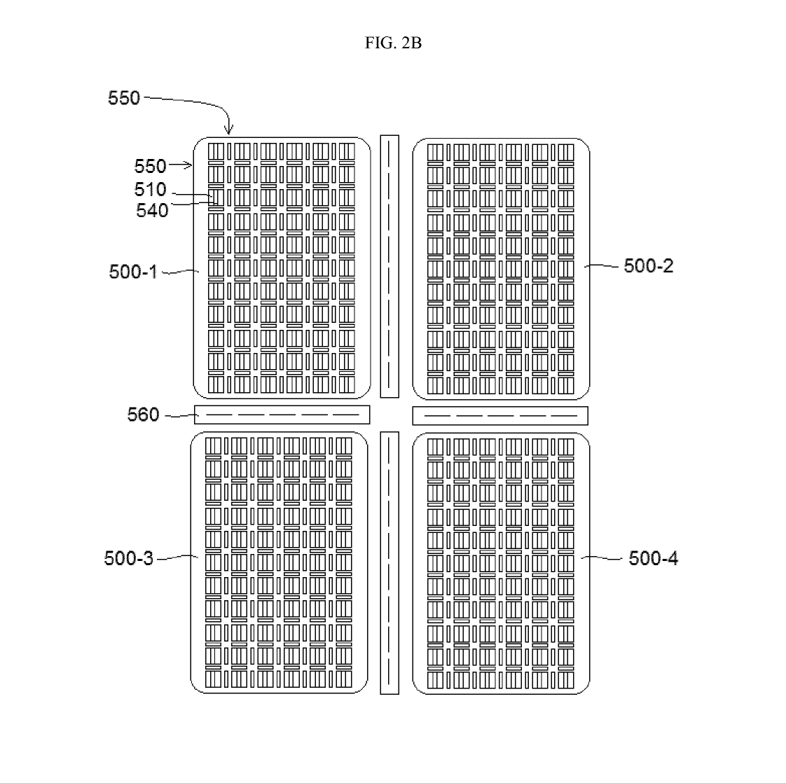

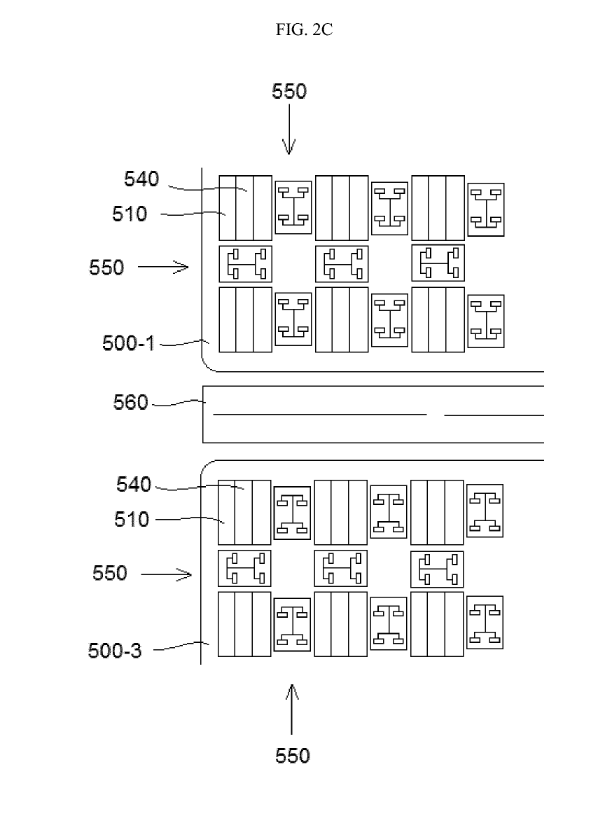

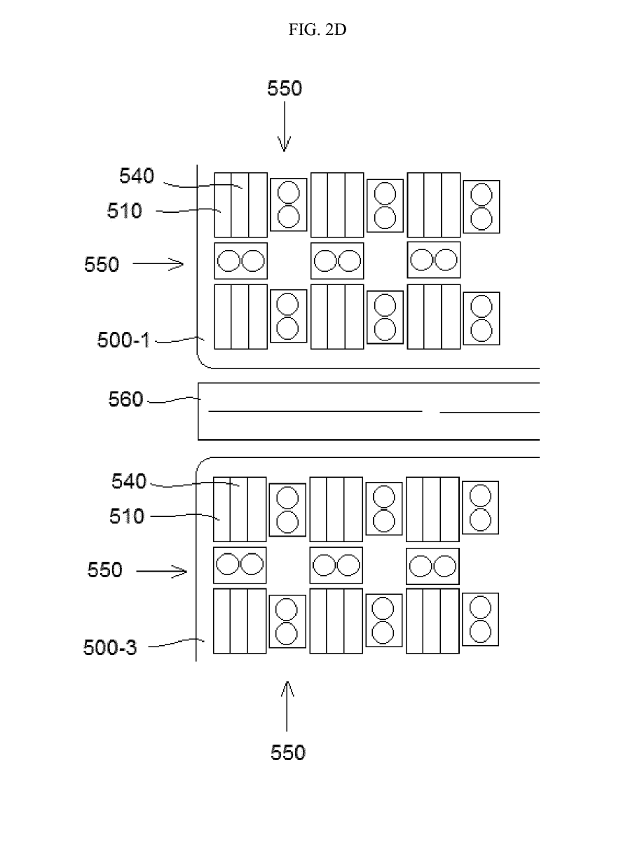

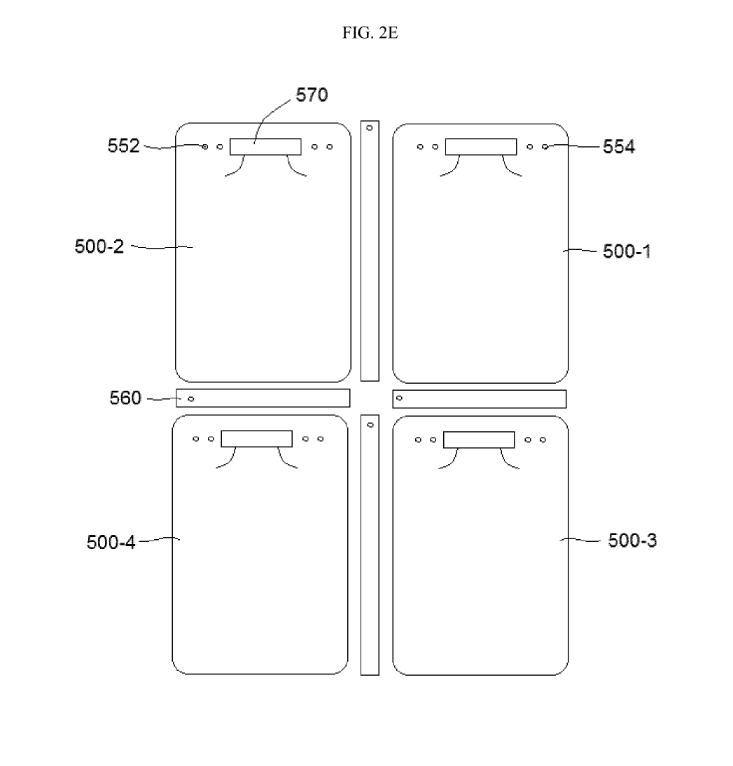

In example embodiments, the solar powered antenna 500 may comprise various solar cells 510 integrated with antennas configured as very high frequency, ultrahigh frequency, and/or mm (millimeter) wave antennas. As shown in FIG. 2A, the solar cells 510 may be arranged on a ground plate 520 and may be covered with a transparent material 530, for example, glass. In one nonlimiting example embodiment, antenna elements 540 may be arrayed on the transparent material 530. The antenna elements 540 may, for example, be substantially transparent, for example, 90% transparent, patch antennas. Space between the solar cells 510 may include additional antennas 550, for example, linear patch antennas, polar patch antennas, PCB dipole antennas and/or slot antennas, which may be used in the high frequency to mm frequency ranges. These antennas 550 may be phase controlled to allow steerable beams to insure proper connectivity with an orbiting satellite (to be explained later).

FIG. 2B illustrates a specific nonlimiting example of an array of solar powered antennas 500 and FIG. 2C illustrates a close-up view of the array of solar powered antennas 500. In this specific nonlimiting example, the array of solar powered antennas includes a first solar powered antenna 500-1, a second solar powered antenna 500-2, a third solar powered antenna 500-3, and a fourth a solar powered antenna 500-4. As shown in FIG. 2B, the solar panels 500-1, 500-2, 500-3, and 500-4 may be comprised of a plurality of solar cells 510. Although each of the solar panels 500-1, 500-2, 500-3, and 500-04 are illustrated as comprising sixty solar cells 510, it is understood the number of solar cells 510 shown is simply for the purpose of illustration and is not intended to limit the invention as the solar panels 500-1, 500-2, 500-3, and 500-4 may actually include more or less than sixty solar cells 510.

Referring again to FIGS. 2B and 2C, the solar cells 510 may have substantially transparent patch antennas 540 placed thereon. Additional patch antennas 550 may also be placed between the solar cells 510. In addition, slot antennas 560 may be placed between the solar panels 500-1, 500-2, 500-3, and 500-4. This arrangement provides for a relatively compact solar powered antenna 500 wherein various antennas thereof (540, 550, and 560) may be powered by the solar cells 510. One skilled in the art might understand the patch antennas 550 illustrated in FIG. 2C to be linear patch antennas, however, while linear patch antennas are usable the invention is not limited thereto. For example, in FIG. 2D the patch antennas 550 are illustrated as polar patch antennas.

FIG. 2E illustrates a backside of the solar panels 500-1, 500-2, 500-3, and 500-4. As shown in FIG. 2E the solar panels 500-1, 500-2, 500-3, and 500-4 may include solar DC connections 570 as well as antenna vertical RF connections 552 and antenna horizontal RF connections 554, for example, Type N, SMA, and K. The slot antenna may include a slot antenna RF connection 560 (for example, a wave guide to RF connection).

In example embodiments, the communication system 1000 may actually include multiple interconnected solar panels 500. For example, the solar panels 500 may be interconnected for the RF (radio frequency) portion of these antennas such as the DC interconnectivity of the solar panels for power generation. The RF interconnectivity of the solar panels 500 may allow for increasing the gain and efficiency of the antenna arrays within these solar panels as they may be connected in either a series or parallel configuration. Another advantage of chained solar panels 500 and integrated phasing controls is that the radiation pattern of the solar panel antenna arrays can have their radiated beams controlled in phase. The directivity may be steered electronically to communicate effectively with various satellites (to be explained). In addition, Wi-Fi antennas may be integrated in the solar powered antenna 500 so the solar powered antenna 500 can function as a Wi-Fi Hotspot which may allow connectivity to various WEB connections.

In example embodiments, conventional solar panels may be retrofitted with antennas to form the solar powered antenna 500. For example, a conventional solar panel may be retrofitted with antennas mounted at top edges of the panels or inserted between panels. For the latter embodiment, slot antennas may work well. In addition, the retrofitted solar powered antennas 500 may include patch antennas that may be linear or circularly polarized. Other antennas that may be usable in the solar powered antenna 500 include slot antennas (both PCB and waveguide).

In example embodiments, the solar powered antenna 500 may provide enough power, via its solar cells 552, to power the antennas that may be incorporated therein. Also, the solar powered antenna 500 (or array of solar powered antennas 500) may provide power to other elements of the communication system 1000, for example, the computer 100, the RF transceiver 200, the RF Modem 300, and the RF/Antenna Tuner and Phase controller 400. In addition, the solar powered antenna 500 may provide electricity to a battery which may be used to power the antennas of the solar powered antenna 500, or the other elements of the communication system 1000, in the event solar energy is low or not available. Because the solar powered antenna 500 does not require an external power source to operate (other than a battery when solar energy is not available) the solar powered antenna 500 may be placed in remote areas where traditional antennas cannot operate due to a lack of power.

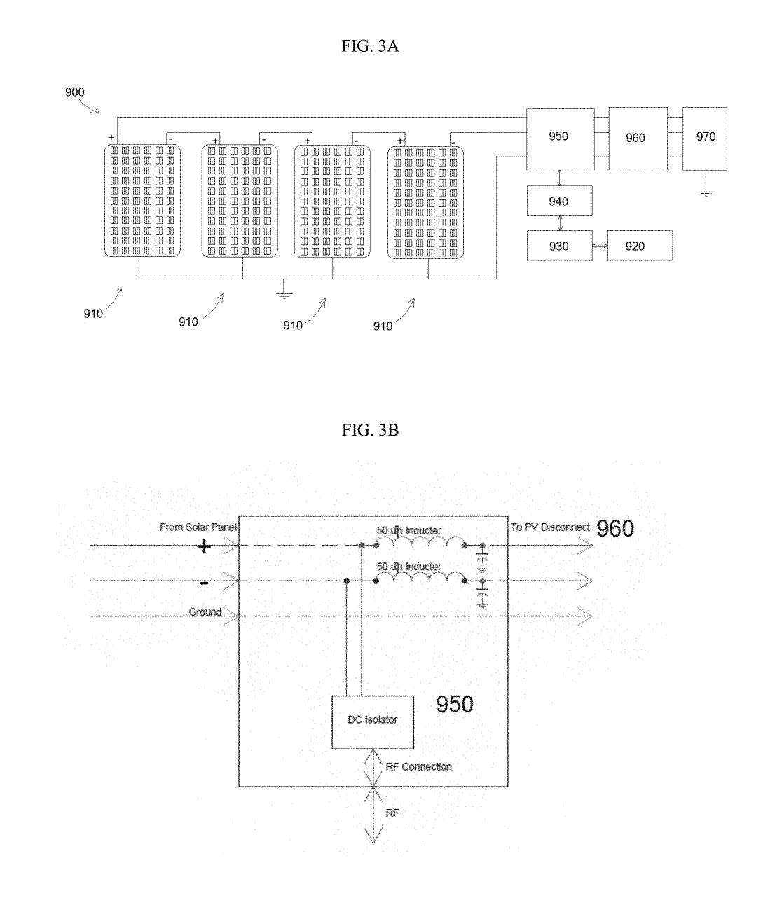

The invention also contemplates a system 900 which utilizes existing wiring in conventional solar panels as a means to convert the solar panel into an antenna. This would avoid having to retrofit conventional solar panels with antennas. FIG. 3A, for example, illustrates an example system 900 having a plurality of conventional solar panels 910. Although FIG. 3A illustrates the plurality of conventional solar panels 910 as comprising four solar panels the number of panels is exemplary only and could comprise a single solar panel, less than four solar panels, or more than four solar panels. Similarly, while FIG. 3A shows the solar panels 910 in series they could alternatively be in parallel or connected together in a combination of parallel and series configurations. In the system 900 of FIG. 3A, the system 900 further includes a ground span line 920 which may be a computer interface allow a user to utilize the system 900. The system 900 further includes an RF transmitter/Receiver 930, an RF tuner 940, an RF/DC isolator 950, a PV disconnect 960, and an inverter 970. In example embodiments the RF tuner 940 may feed an RF signal to the RF/DC isolator 950 which imposes the RF signal on the wires of the solar panels 910. FIG. 3B illustrates the RF/DC isolator 950 in greater detail. By imposing the RF signal on the wires of the solar panels 910 the solar panels 910 may act as an antenna. As such, while certain embodiments of the invention contemplate incorporating various antennas and photovoltaic cells together in a solar panel, the invention is not limited thereto. The system 900 may be used in lieu of the previously described system 1000.

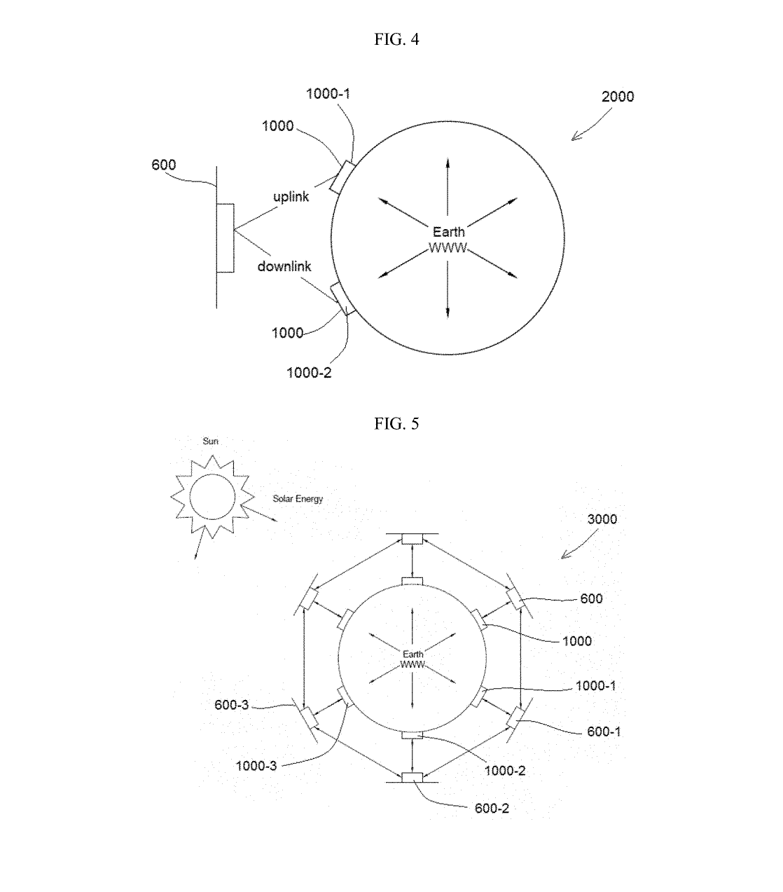

FIG. 4 is a view of a system 2000 that utilizes the communication system 1000. As shown in FIG. 4, the system 2000 includes not only the communication system 1000 but a satellite 600. The satellite 600, for example, may be a CUBESAT, SMALLSAT, or any other suitable satellite. In at least one nonlimiting example embodiment, the satellite 600 is fitted with at least one solar powered antenna, that is, an antenna integrated into a solar panel having photovoltaic cells. As such, the solar panels of satellite 600 may resemble the previously described solar panel 500. In this way, the satellite 600 possesses an antenna which allows it to communicate with antennas 500 of the communication system 1000.

In the nonlimiting embodiment of FIG. 4, the satellite 600 may receive a signal from one of the communication systems 1000 and relay the signal to another ground station 1000. In other words, the system 2000 of FIG. 3 represents a satellite link comprised of an uplink and a downlink. In this way, the satellite 600 allows a user of one of the communication ground stations 1000 to communicate with user of another ground station 1000. In the event one of the communication ground stations 1000 is connected to the Internet, the satellite link allows the other communication ground station 1000 access to the Internet via the satellite 600 and one communication ground station 1000 having access to the Internet.

In example embodiments the solar powered antennas may be configured to act as both uplink and downlink antennas. This may be accomplished by configuring some of the antennas of a solar panel to function as an uplink antenna while configuring other antennas of the solar panel to function as downlink antennas. This provides increased flexibility in the use of the previously described systems.

In a nonlimiting example embodiment, the satellite 600 is placed in a geosynchronous or geostationary orbit and in a position to provide communication between two or more communication systems 1000 arranged on the surface of the earth. In some embodiments, the satellite 600 is placed in a low Earth orbit, in other embodiments, the satellite 600 is placed at higher altitudes. The inventor also anticipates that the orbital paths may also constitute a polar orbit. The communication systems 1000 may be placed at various regions on the earth at regions where they can upload and download information from the satellite 600. For example, in FIG. 4, a first communication system 1000-1 may send a signal to the satellite 600 and the satellite 600 may forward this signal to a second communication system 1000-2.

FIG. 5 is a view of another system 3000 that utilizes a plurality of communication systems 1000. As shown in FIG. 5, the system 3000 includes not only the plurality of communication systems 1000 but a plurality of satellites 600. The satellites 600, as in system 2000, may be CUBESATS, SMALLSATS, or any other suitable satellite that may be placed in low Earth orbit or a higher altitude orbit. In this nonlimiting example embodiment, the satellites 600 may receive a signal from one of the communication systems 1000 and may relay the signal to another of the ground stations 1000. As such, in the system 3000, a plurality of satellite links may be comprised of various uplinks and downlinks. In this way, the satellites 600 allow users of one of the communication ground stations 1000 to communicate with users of other ground stations 1000 serviced by the same or different satellites 600. In the event one of the communication ground stations 1000 is connected to the Internet, the satellite links allow the other communication ground stations 1000 access to the Internet via the satellite 600 and one communication ground station 1000 having access to the Internet.

In example embodiments, the satellites 600 of system 3000 may be configured to transmit data between them. This allows a user of one ground station 1000 to connect to a user of a remote ground station. For example, in FIG. 5, a user of communication system 1000-1 may communicate to a user of system 1000-2 by sending a signal to satellite 600-1 which in turn transmits the signal to satellite 600-2, which in turn transmits the signal to communication system 1000-2. In this way, various communication stations 1000 can communicate with each other around the earth. As another example, a user of communication system 1000-1 may communicate to a user of system 1000-3 by sending a signal to satellite 600-1 which in turn transmits the signal to satellite 600-2 which in turn transmits the signal to satellite 600-3 which in turn transmits the signal to communication system 1000-3. These latter embodiments illustrate examples of a multi-satellite link comprising one uplink, satellite to satellite links, and one downlink.

As in the previous system, the satellites 600 of system 3000 may be placed in a geosynchronous or geostationary orbit and in a position to provide communication between one or more communication systems 1000 arranged on the surface of the earth. However, the inventor contemplates alternative orbits for the satellites 600 such as a polar orbit.

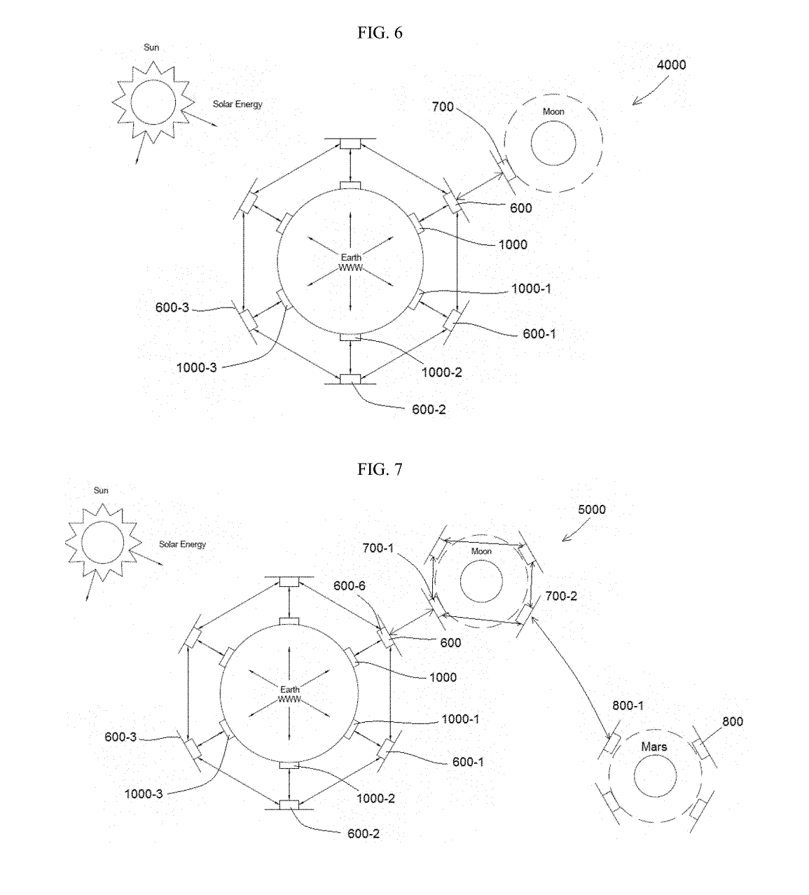

In this application, the above inventive concepts may be extended to outer space communications. For example, FIG. 6 illustrates an example of another system 4000 which uses not only the ground communication systems 1000 and satellites 600, but additional satellites 700 that may be placed in outer space. Like satellite 600, the satellites 700 may include solar panels having antennas integrated therein. In the specific nonlimiting example of FIG. 6, one of the satellites 700 is placed in orbit about the moon. It is understood that while FIG. 6 shows only a single satellite 700 orbiting the moon, satellite 700 may actually represent a cluster of satellites orbiting the moon and arranged in a fashion similar the satellites 600 that orbit the earth. In this system 4000, a user may use their respective communication system 1000 to communicate with one of the satellites 600 and the satellite 600 may, in turn, communicate with one of the satellites 700 either directly or indirectly. In this manner, communication between a user on the ground the satellites 700 in outer space may be facilitated.

In this application, the above inventive concepts may be extended to further outer space communications. For example, FIG. 7 illustrates an example of another system 5000 which uses not only the communication systems 1000, satellites 600, satellites 700 but additional satellites 800 remote from the moon and Earth. In the alternative, the system 5000 may be used to contact long range spacecraft where the satellite 800 corresponds to the spacecraft rather than an orbiting satellite. For example, in FIG. 7, the additional satellites 800 may be satellites orbiting another planet or body, for example, Mars or an asteroid. In this system 5000, a user may use their respective communication system 1000 to communicate with one of the satellites 600 and the satellite 600 may, in turn, communicate with one of the satellites 700, which may, in turn, communicate with one of the satellites 800 orbiting the planet or body. In this manner, communication between a user on the ground and a body deep in space may be facilitated. For example, if a user using communication system 1000-3 on Earth wanted to communicate with Mars, the user may use the communication system 1000-3 to send a message to satellite 600-3 which, in turn, may send the message to satellite 600-2 which, in turn, may send the message to satellite 600-1 which, in turn, may send the message to satellite 600-6 which may, in turn, send the signal to satellite 700-1 which may, in turn send the signal to satellite 700-2 which may, in turn send the signal to satellite 800-1 which may orbit Mars. Of course, communication from satellite 800-1 to the user may occur by sending a message to satellite 700-2 which may, in turn, send the message to satellite 700-1 which may, in turn send the message to satellite 600-6 which may send the message to satellite 600-1 which may, in turn, send the message to satellite 600-2 which may, in turn, send the message to satellite 600-3 which may, in turn, send the message to communication system 1000-3.

Example embodiments greatly improve the art. For example, in accordance with the inventive concepts taught herein, large solar fields, which have been traditionally used for the purpose of generating renewable energy, can now be utilized to provide an alternate means of communications with greater speed and data rates currently found in the WWW (World Wide Web). Furthermore, remote areas of the Earth now can have access to clean energy and an interconnectivity with the rest of the Globe and other planets that will have the satellite systems in place. With the positioning of the clusters of satellites, such as SmallSats and CubeSats, communications can be obtained at any time with our without the sun.

The inventor notes the world wide web is at capacity at times based on its current structure. Applicant's systems, by operating at MM waves, for example, around 30 GHz, will have ample bandwidth for streaming data at 20 times the rate currently found with current web and Wi-Fi systems. Applicant's systems will allow interconnectivity anywhere a solar panel integrated with antennas can be installed. The overall system is scalable from a small one solar panel with integrated antennas to large fields of such solar panels.

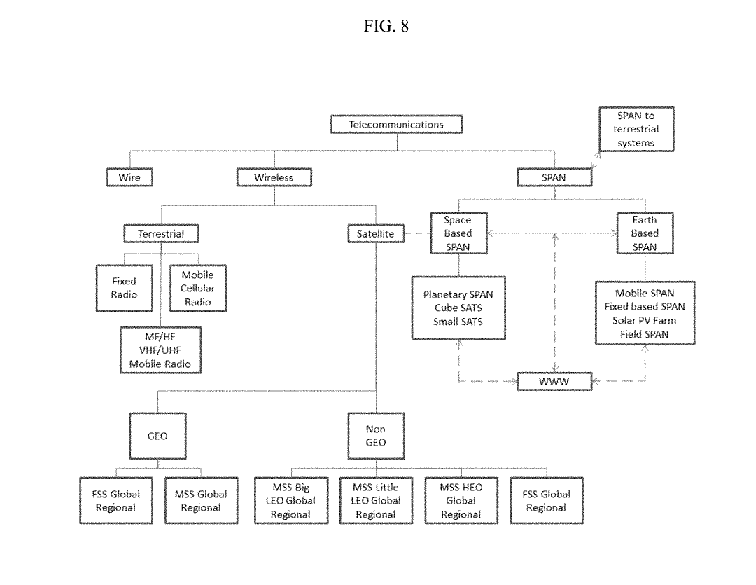

FIG. 8 illustrates general state of the art communications equipment and systems adjacent to the inventor's communication system(s) comprising a plurality of solar powered antennas. As shown in FIG. 8, the inventor's system may easily work in conjunction with the conventional telecommunication system enabling users of the conventional art to communicate with the inventor's global and interplanetary wide web.

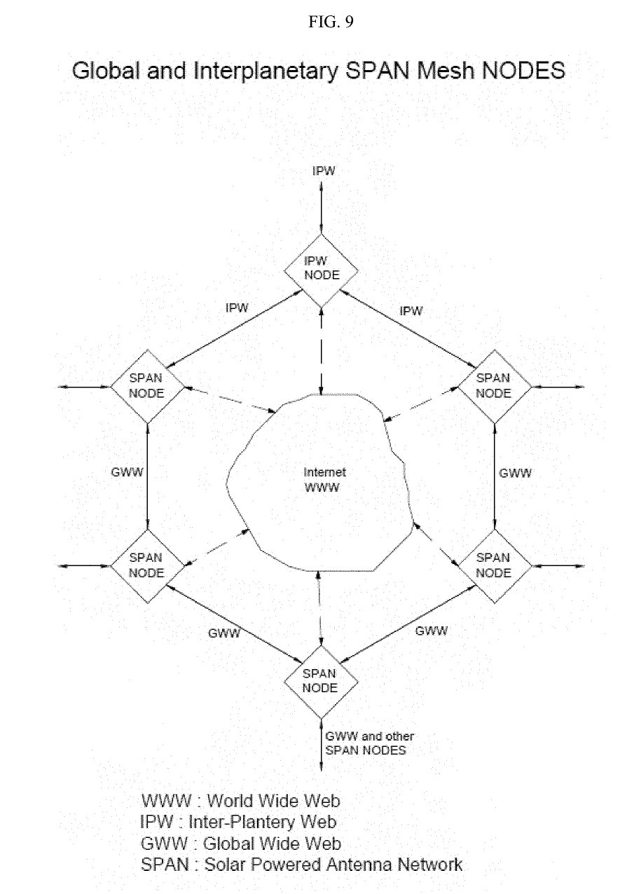

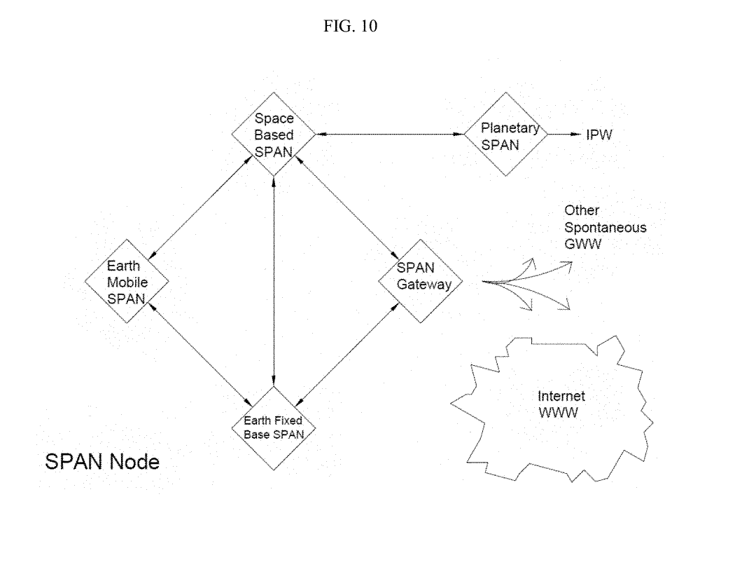

FIGS. 9 and 10 are schematic views of the inventor's systems showing how various aspects of the inventor's system may interconnect in accordance with a nonlimiting example embodiment of the inventor's invention. For example, FIG. 9 shows an example where various SPAN nodes associated with inventor's global wide web interact with both the internet as well as a node associated with the inventor's interplanetary wide web.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

1. A global wide web (GWW) comprising:
a plurality of ground based communication systems comprising: at least one solar panel; at least one integrated antenna configured to operate in at least one of a very high frequency, an ultrahigh frequency, and a millimeter (mm) frequency range disposed over the at least one solar panel, a material that is substantially transparent to sunlight disposed between the integrated antenna and the solar panel; and
a plurality of satellites orbiting Earth, wherein the plurality of satellites is configured to communicate directly with one another and with at least one of the plurality of ground based communication systems, wherein at least one of the plurality of satellites has a connection to the Internet to thereby allow all of the plurality of ground based communication systems to have an Internet connection.

2. The global wide web of claim 1, wherein the at least one integrated antenna is one of a patch antenna, a dipole antenna, and a slot antenna.

3. The global wide web of claim 1, wherein the at least one solar panel is a plurality of solar panels having steerable antennas.

4. The global wide web of claim 1, wherein the plurality of satellites each include at least one solar panel with at least one integrated antenna configured to operate in at least one of the very high frequency, ultrahigh frequency, and mm frequency range.

5. The global wide web of claim 4, wherein the at least one integrated antenna associated with the plurality satellites is one of a patch antenna, a dipole antenna, and a slot antenna.

6. An Inter-planetary web (IPW) comprising:
the global wide web of claim 1, wherein the plurality of satellites is a first plurality of satellites; and
a second plurality of satellites remote from the first plurality of satellites.

7. The Inter-planetary web according to claim 6, wherein the second plurality of satellites each include at least one solar panel with at least one integrated antenna configured to operate in at least one of the very high frequency, ultrahigh frequency, and mm frequency range.

8. The Inter-planetary web of claim 7, wherein the at least one integrated antenna associated with the second plurality satellites is one of a patch antenna and a slot antenna.

9. The Inter-planetary web of claim 6, wherein the second plurality of satellites orbit a body other than the Earth.

10. The Inter-planetary web of claim 9, wherein the body is Mars.

11. A solar panel, comprising:
an integrated antenna configured to operate in at least one of a very high frequency, an ultrahigh frequency, and a millimeter (mm) frequency range, a material that is substantially transparent to sunlight disposed between the integrated antenna and the solar panel.

12. The solar panel of claim 11, wherein the integrated antenna is 90% transparent to sunlight.

13. The solar panel of claim 11, wherein the integrated antenna is one of a patch antenna, a dipole antenna, and a slot antenna.

14. The solar panel of claim 11, wherein the integrated antenna comprises a wire of the solar panel.

15. The solar panel of claim 11, wherein the integrated antenna is powered by the solar panel.

16. A ground based communication system, comprising the solar panel of claim 11.

17. The ground based communication system of claim 16, wherein the solar panel is a first solar panel, and the integrated antenna is a first integrated antenna, and the ground based communication system further comprises: a second solar panel comprising a second integrated antenna.

18. The ground based communication system of claim 17, wherein the first and second integrated antennas are adapted to be steered.

19. The ground based communication system of claim 18, wherein the first and second integrated antennas are phase controlled.
